(19) United States
(12) Patent Application Publication
(10) Pub. No.: US 2010/0318414 A1
(43) Pub. Date: Dec. 16, 2010

(54) INTERACTIVE ADVERTISING ON CALL TERMINATION FOR MOBILE TERMINALS

(75) Inventor: Pekka Ettala, Helsinki (FI)

Correspondence Address: BIRCH STEWART KOLASCH & BIRCH, PO BOX 747, FALLS CHURCH, VA, 22040-0747, US

(73) Assignee: MADTAG OY, Helsinki (FI)

(21) Appl. No.: 12/867,515

(22) PCT Filed: Feb. 13, 2009
(86) PCT No.: PCT/FI2009/050113

§ 371 Date: Aug. 13, 2010

(30) Foreign Application Priority Data
Feb. 14, 2008 (FI) 20080111

(51) Int. Cl. G06Q 30/00; H04W 4/12

(52) U.S. Cl. 705/14.4; 455/414.1; 455/412.1

(57) ABSTRACT

Call or call alarm terminating method and system in a mobile telecommunication system, whereby a user (caller, USER1) having a calling mobile telecommunication terminal device (MOBILE1) makes a call to another user (recipient, USER2) having a called mobile telecommunication terminal device (MOBILE2), wherein when one of the user has finished the call or call alarm desired media, like an advertisement, is displayed at the called and/or calling terminal display, wherein the user of the called or calling terminal device responds to the media by giving an input via the interface of the called or calling terminal device, the called or calling terminal device executes one or several operations based on the input from the user.

### FIELD OF THE INVENTION

The present invention relates to call termination in a mobile telecommunication system.

### BACKGROUND OF THE INVENTION

US2007244752 discloses a system and method for providing a mobile terminal user a rebate for the charge of a call when the user views an advertisement after the completion of the call. The user may have to view the advertisement within a specified time following the call established by the system administrator and respond to a question about the advertisement in order to earn a full or greater rebate. Viewing the advertisement may be done on the user's mobile terminal's LCD, or via an Internet enabled PC. Users who choose the latter, may access the advertisement by clicking on a hyperlink sent to them via email, or by accessing the service provider's website using a unique user PIN to login. Service providers select advertisements based on factors including location, day, time, and the user's demographic and personal interests. In a prepaid system, prepaid users may have their accounts conditionally debited pending the viewing of an advertisement. The operating environment includes at least one wireless handset terminal and one computer having a monitor (PC) that is enabled to access the Internet, that the user has access to. The user's terminal is preferably MS enabled. The user's terminal includes a transceiver for an over the air interface such as GSM or CDMA to communicate with a Mobile Switching Center (MSC) call processing system. A telecommunication system connects the user's phone and the MSC, and the MSC connects the user's terminal to an HTTP (internet web) server via a wireless protocol gateway server in the MSC. The HTTP server connects the user's terminal to at least one website containing downloadable advertising content. For purpose of illustration the wireless protocol gateway server will be discussed in terms a of a “WAP gateway”, as it is the most common standard, but it is only meant to be an illustration and not meant to be a limitation, as the gateway can be any wireless protocol compatible with the phone service provider's network platform. Additionally, the telecommunication system connects the PC to the MSC, so that the user may receive a hyperlink emailed by the MSC, and follow it to a sponsor advertisement, or otherwise directly access a sponsor advertiser website having an advertisement. The telecommunication system may be any public and or private communication network. In certain embodiments, the telecommunication system is the Public Switched Telephone Network (PSTN). The telecommunication system may include wired and or wireless (“3G”) segments and may carry digital and/or analog signals. In alternate embodiments, the telecommunication system may take other forms, such as a voice over IP network or other types of data networks. A method of providing advertisements to a prepaid user of a mobile terminal of a prepaid mobile communications system is further disclosed, comprising: identifying the mobile terminal utilized by the prepaid user; determining whether a sufficient credit balance exists on the prepaid user's account to make or receive a call; if the account has the sufficient credit balance, prompting the prepaid user to choose to have the call subsidized by viewing an advertisement after the call; if the prepaid user chooses to have the call subsidized, selecting an advertisement; making or receiving the call; and making the advertisement available to the user for viewing after the call. Typical for this kind of prior art advertising system is that it has no interactivity, ie. the advertisements are simply displayed in the display of the terminal device without any possibility to interactivity.

### SUMMARY OF THE INVENTION

The object of the present invention is to overcome the problems and limitations with the prior art call termination systems.

The present invention is based on an idea that instead of only displaying an advertisement the user, especially the recipient, gets a possibility to react to the advertisement or other media steered to and displayed at the recipient's mobile phone display after the phone call has been terminated.

This is implemented as follows:

the calling terminal (client) calls the receiving or called terminal (client), the called client having a so called Complete Mobile Advert Manager (CMAM) software application,

which is downloadable from a www server or being preinstalled by the manufacturer of the mobile terminal,

when one of the terminals has finished the call, an advertisement is right after the termination displayed at the called terminal display, the advertisement being steered to the called terminal by the CMAM,

if the calling terminal is a 3G or any future generation device and also has the CMAM installed the advertisement is also displayed in the calling terminal right after the termination of the call,

the advertisement may be displayed in the called terminal irrespective the type of the calling device (wired, VoIP, mobile etc device).

The advertisement is displayed at the display of the receiving terminal right after when either of the terminals have shut down the call connection. Also the calling terminal will get the advertisement if it is 3G and has the CMAM application. The advertisement will appear on the display as long as the user decides if he/she wants to download the advertisement onto the terminal's memory card by clicking the “save” link at the display or predetermined key simple or remove it from the display by pressing any key of the keypad.

The present invention is in detail defined in the enclosed claims, especially in the independent method and system claims.

By means of the present invention it is possible that, on the contrary to the conventional systems, the called party may interactively execute desired operations according to the media received after the call. This provides a totally new way of mobile communication and especially call termination possibilities.

Many kind of mobile telecommunication systems and terminal devices, such as communicators etc, having 3G, GPRS or corresponding properties may be used in the present invention.

### BRIEF DESCRIPTION OF THE FIGURES

In the following, preferred embodiments of the present invention will be described in detail by reference to the enclosed drawings, wherein

FIG. 1 presents a schematical view of a 3G mobile telecommunication system.

FIG. 2 presents a block diagram of the operation of mobile call termination procedure according to the present invention.

### DETAILED DESCRIPTION OF PREFERRED EMBODIMENTS

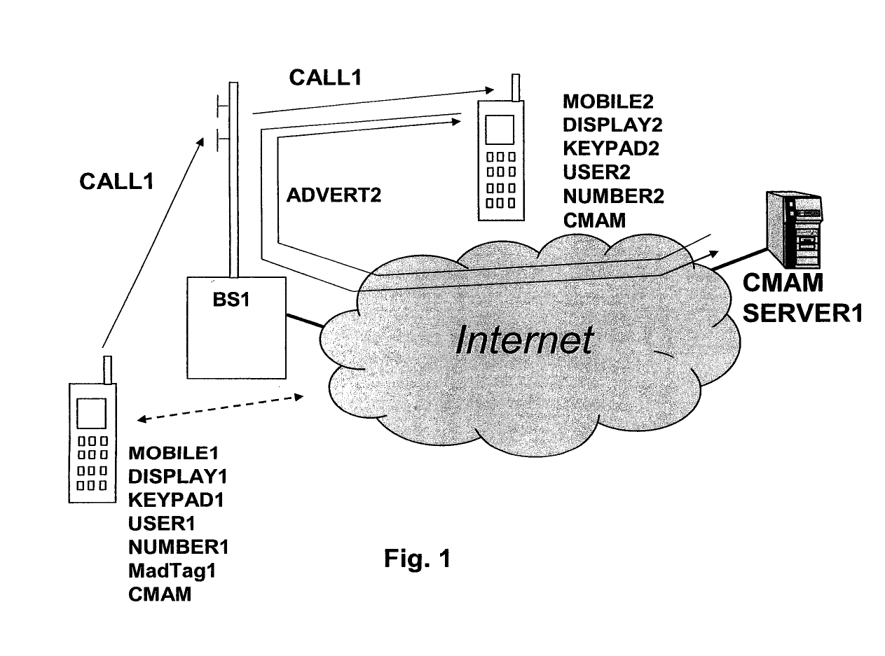

FIG. 1 presents of a 3G mobile telecommunication system operating with a 3G protocol and comprising users having 3G mobile phones, here for simplification only two, USER1 with MOBILE1 and USER2 with MOBILE2 with display DISPLAY1, DISPLAY2, and keypad KEYPAD1, KEYPAF2 who are in communication with each other via the 3G network having base stations, here for simplification only one BS1. All users in a 3G network having a 3G mobile phone have access to Internet and may use the Internet and its services provided for 3G networks.

Each phone is a 3G mobile phone provided with corresponding processor and memory capacity and further provided in this embodiment with an Symbian Operative System which is a proprietary operating system, designed for mobile devices, with associated libraries, user interface frameworks and reference implementations of common tools, produced by Symbian Ltd. It runs exclusively on ARM processors.

A calling user USER1 makes a telephone call CALL1 to another client USER2 with his mobile phone MOBILE1 by dialing the recipient's telephone number NUMBER2 or selecting it from the telephone book. The called (receiving) mobile phone MOBILE2 alerts for incoming call.

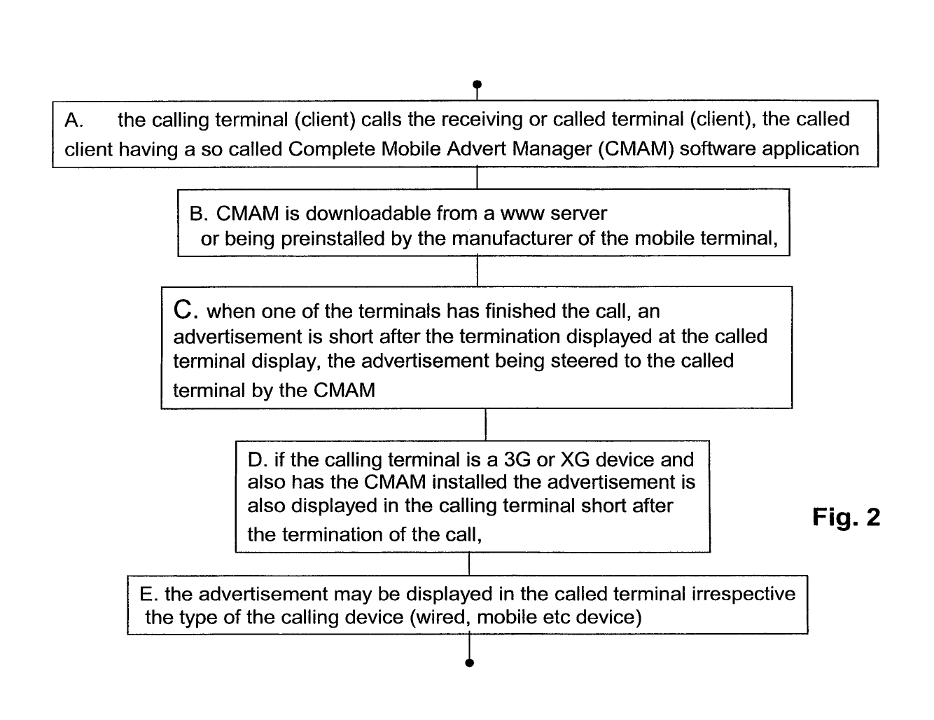

Each phone utilizing the present invention is provided with a Complete Mobile Advert Manager (CMAM) software application operating as a client software application the operation and structure of which is described in the following in further detail, based on FIG. 2, points A to E.

The calling terminal (client) calls the receiving or called terminal (client), the called client having a so called Complete Mobile Advert Manager (CMAM) software application, which can be downloaded from a Internet www server CMAM Server1 or being preinstalled by the manufacturer of the mobile terminal.

When one of the terminals has terminated the call, an advertisement is displayed right after, typically in some milliseconds, the termination at the called terminal display, the advertisement being steered and downloaded during the call from the server SERVER1 to the called terminal by the CMAM.

If the calling terminal is a 3G or XG device and also has the CMAM installed the advertisement is also displayed in the calling terminal short after the termination of the call.

Further, in 3G or XG the downloading can be arranged so that when the call signal arrives the receiving terminal (i.e. the call is coming but the call alarm signal cannot not necessarily be yet heard in the receiving terminal) the software application begins to search a first tag (e.g. an advertisement that is displayed during the call and/or call alarm) from the server, and when this first tag has arrived into the terminal, the software application begins immediately to search the second, call termination tag from the server and this second, call termination tag is then displayed at the display, short after the termination of the call. In 2G the process is otherwise similar but it is started first when the call has been terminated.

The advertisement may be displayed in the called terminal irrespective the type of the calling device (wired, mobile etc device), and also even if the recipient does not answer to the call after the user has stopped the phone alarm. The advertisement may be text, images, video clips and their combinations.

The advertisement is displayed at the terminal display after the call and may be deleted from the display when the user presses any of the keys in the terminal keypad. It is also possible to press a desired key to store the advertisement in the mobile terminal's memory.

It is obvious to the person skilled in the art that the embodiments of the invention are not restricted to the example presented above, but that they can be varied within the scope of the following claims. The termination of the call may also launch other applications. If for example a ticket is displayed at the display, the ticket may be bought by pressing a desired key in the keypad. The desired button may be shown in the display. In addition, discount coupons, free tickets, links to a web store can be displayed at the display.

The mobile telecommunication system may be a 3G network i.e. third generation of mobile phone standards and technology providing wide area cellular telephone networks which evolved to incorporate Internet access and video telephony, or a General Packet Radio Service (GPRS) network providing Mobile Data Service available to users of Global System for Mobile Communications (GSM) and IS-136 mobile phones or any other mobile telecommunication system having high rate data transmission e.g. capable of having access to Internet. The CMAM Server1 may collect and store log information from the advertisements displayed and this log information can then be e.g. the basis for debiting the advertising organisation.

1. A call or call alarm terminating method in a mobile telecommunication system, whereby a user having a calling mobile telecommunication terminal device makes a call to another user having a called mobile telecommunication terminal device, said method comprising the steps of:
when one of the users has finished the call or call alarm, displaying desired media at a called and/or calling terminal display;
the user of the called or calling terminal device responding to the media by giving an input via the interface of the called or calling terminal device; and
the called or calling terminal device executing one or several operations based on the input from the user.

2. The method according to claim 1, wherein the input is given by pressing a key or keys in the terminal keypad.

3. The method according to claim 1, wherein the displayed media includes input information for the user.

4. The method according to claim 1, wherein the input launches a desired operation of a software.

5. The method according to claim 1, wherein the displayed is retrieved form a server in a computer network.

6. The method according to claim 1, wherein the desired media is displayed also at the calling terminal display.

7. A call terminating system in a mobile telecommunication system, whereby a user having a calling mobile telecommunication terminal device is capable of making a call to another user having a called mobile telecommunication terminal device wherein when one of the user has finished the call, desired media is configured to be displayed at the called and/or calling terminal device display, wherein the system includes media so that the user of the called and/or calling terminal device is capable of responding to the media by giving an input via the interface of the called terminal device, the called and/or calling terminal device is configured to execute one or several operations based on the input from the user.

8. The system according to claim 7, wherein the input is given by pressing a key or keys in the terminal keypad.

9. The system according to claim 7, wherein the displayed media includes input information for the user.

10. The system according to claim 7, wherein the input launches a desired operation of a software.

11. The system according to claim 7, wherein the displayed is retrieved from a server in a computer network.

12. The method according to claim 1, wherein when one of the terminals has terminated the call or the call alarm, the media is displayed right after, typically in some milliseconds, the termination at the called terminal display, wherein the displayed is an advertisement and the advertisement is steered and downloaded during the call to the terminal device or devices.

13. The method according to claim 1, wherein log information from the displayed is collected and stored for further processing.

14. The system according to claim 7, wherein the system is adapted so that when one of the terminals has terminated the call or the call alarm, the media is displayed right after, typically in some milliseconds, the termination at the called terminal display, the displayed being steered and downloaded during the call to the terminal device or devices from a media server.

15. The system according to claim 1, wherein the system includes a server collecting and storing log information from the displayed for further processing.

16. The method according to claim 2, wherein the displayed media includes input information for the user.

17. The method according to claim 2, wherein the input launches a desired operation of a software.

18. The method according to claim 3, wherein the input launches a desired operation of a software.

19. The method according to claim 2, wherein the displayed is retrieved from a server in a computer network.

20. The method according to claim 3, wherein the displayed is retrieved from a server in a computer network.
